(19) United States
(12) Patent Application Publication
(10) Pub. No.: US 2012/0131305 A1
(43) Pub. Date: May 24, 2012

(54) PAGE AWARE PREFETCH MECHANISM

(76) Inventor: Swamy Punyamurtula, Austin, TX (US)

(21) Appl. No.: 12/951,567

(22) Filed: Nov. 22, 2010

(51) Int. Cl. G06F 12/10

(52) U.S. Cl. 711/204; 711/E12.059

(57) ABSTRACT

A processor includes a prefetch aware prefetch unit having a storage with a number of entries, and each entry corresponds to a different prefetch data stream. Each entry may be configured to store information corresponding to a page size of the prefetch data stream, along with, for example, an address corresponding to the prefetch data stream. For each entry, the prefetch unit may be configured to determine whether a prefetch of data in the data stream will cross a page boundary associated with the data stream based upon the page size information.

### BACKGROUND

1. Technical Field

This disclosure relates to processors and, more particularly, to prefetch mechanisms within the processors.

2. Description of the Related Art

Computer system processor performance is closely related to cache memory system performance in many systems. As processor technology has advanced and the demand for performance has increased, the number and capacity of cache memories has followed. Some processors may have a single cache or single level of cache memory, while others may have multiple levels of caches. Cache memories may be defined by levels, based on their proximity to execution units of a processor core. For example, a level one (L1) cache may be the closest cache to the execution unit(s), a level two (L2) cache may be the second closest to the execution unit(s), and an level three (L3) cache may be the third closest to the execution unit(s).

Data may be typically loaded into a cache memory responsive to a cache miss. A cache miss occurs when requested data is not found in the cache. Cache misses are undesirable, as the performance penalty associated with a cache miss can be significant. Accordingly, some processors employ one or more prefetch units. A prefetch unit may analyze data access patterns in order to predict from where in memory future accesses will be performed. Based on these predictions, the prefetch unit may then retrieve data from the memory and store it into the cache before it is requested. Thus, prefetch units may prefetch a predefined number of cache lines ahead of the cache line currently being referenced. When tracking a data stream, prefetch units typically use the physical address for memory accesses to avoid accessing the translation look-aside buffer and to bypass the cache-access logic when prefetch requests are made. Conventional prefetch units are typically limited to generating prefetch requests within the smallest page size supported by the system. Accordingly, in such conventional systems, data streams may be lost at the boundary of the smallest supported page-size, even when large page-sizes are enabled.

### SUMMARY OF THE EMBODIMENTS

Various embodiments of a processor including a prefetch aware prefetch unit. In one embodiment, the prefetch unit includes a storage. The storage includes a number of entries, and each entry corresponds to a different prefetch data stream. Each entry may be configured to store information corresponding to a page size of the prefetch data stream, along with, for example, an address corresponding to the prefetch data stream. For each entry, the prefetch unit may be configured to determine whether a prefetch of data in the data stream will cross a page boundary associated with the data stream based upon the page size information.

In one specific implementation, in response to determining that the prefetch of data will cross the page boundary, the prefetch unit may be configured to inhibit prefetching the data.

In another specific implementation, the prefetch unit may be configured to receive the page size information with each address, and the address may be associated with a cache miss. In addition, for each entry having an active data stream, the prefetch unit may be configured to generate a prefetch address based upon the received address. Further, the prefetch unit may includes compare logic configured to compare the prefetch address for a given data stream to an address corresponding to the page boundary defined by the page size information for the given data stream.

### BRIEF DESCRIPTION OF THE DRAWINGS

FIG. 1 is a block diagram of one embodiment of a computer system including a processing node.

FIG. 2 is a block diagram of one embodiment of a processor core of the system of FIG. 1.

FIG. 3 is a block diagram of one embodiment of the prefetch unit shown in FIG. 2.

FIG. 4 is a flow diagram describing operational aspects of the prefetch unit of FIG. 2 and FIG. 3.

FIG. 5 is a block diagram of a computer accessible storage medium including a circuit database.

Specific embodiments are shown by way of example in the drawings and will herein be described in detail. It should be understood, however, that the drawings and detailed description are not intended to limit the claims to the particular embodiments disclosed, even where only a single embodiment is described with respect to a particular feature. On the contrary, the intention is to cover all modifications, equivalents and alternatives that would be apparent to a person skilled in the art having the benefit of this disclosure. Examples of features provided in the disclosure are intended to be illustrative rather than restrictive unless stated otherwise.

As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six, interpretation for that unit/circuit/component.

### DETAILED DESCRIPTION

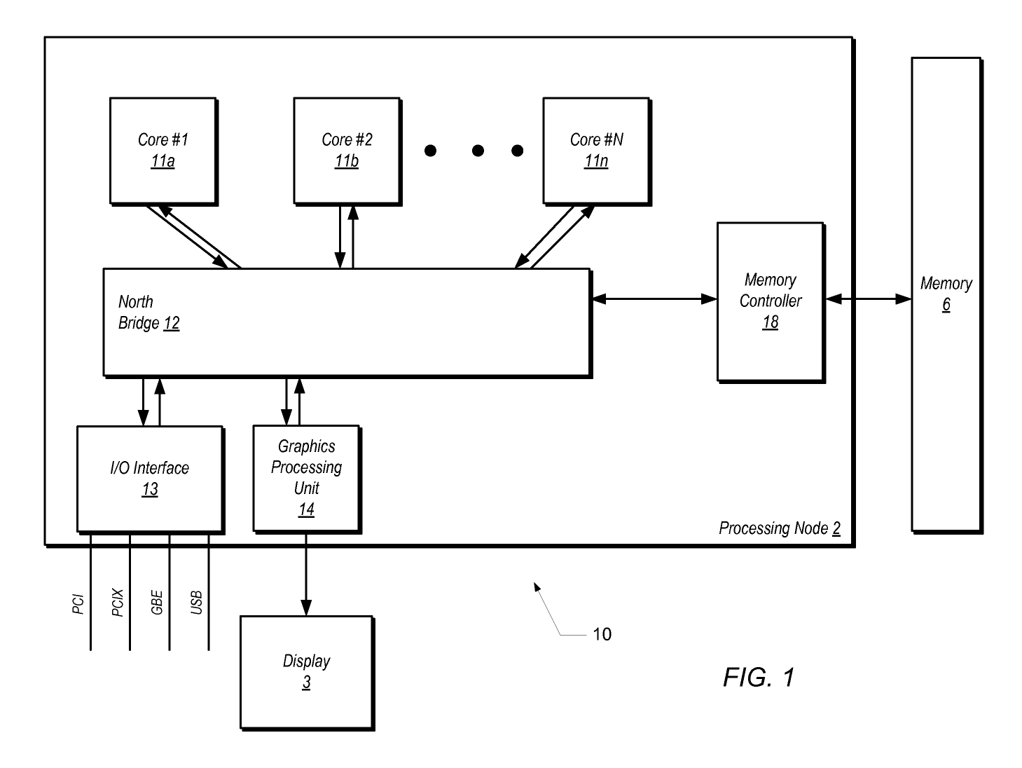

Turning now to FIG. 1, a block diagram of one embodiment of a computer system 10 is shown. Computer system 10 includes a processor such as processing node 2, for example, coupled to a memory 6. As shown, processing node 2 includes a number of processor cores which are designated as 11a, 11b through 11n, where n may represent any number of processor cores. The processing node 2 also includes a north bridge 12 coupled to each processor core 11. The processing node 2 also includes a graphics processing unit 14, a memory controller 18, and an input/output (I/O) interface 13 that are coupled to the north bridge 12. In the embodiment shown, processing node 2 may be a system on a chip (SOC) such as a chip multi-processor (CMP). It is noted that in various other embodiments, any number of processor cores may used. It is also noted that each of processor cores 11 may be identical to each other (i.e. symmetrical multi-core), or one or more cores may be different from others (i.e. asymmetric multi-core). It is further noted that components having a reference designator having both a number and a letter may be referred to using only the number where appropriate. It is noted that other processor architectures and embodiments are possible. While the processor including a graphics processing unit is illustrated in FIG. 1, other embodiments may not include all of the elements illustrated (e.g., alternatives may not include multiple processing cores, graphics processing units, etc.). Additionally, processing node 2 may alternatively embody different types of processors such as central processing units, graphical processing units, digital signal processors, applications processors and the like. These and other apparatus embodying aspects of the invention are contemplated.

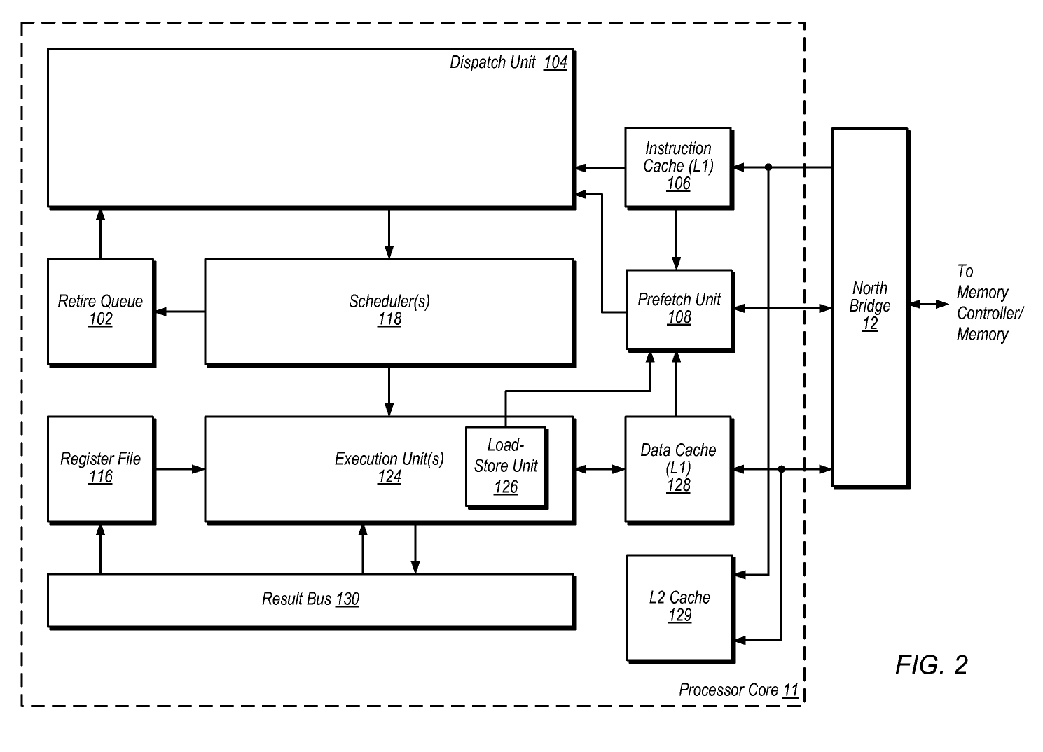

As described further below in conjunction with the description of FIG. 2, a give processor core 11 may include one or more execution units, cache memories, prefetch units, schedulers, branch prediction circuits, and so forth. Furthermore, each of processor cores 11 may be configured to assert requests for access to memory 6, which may function as the main memory for computer system 10. Such requests may include read requests and/or write requests, and may be initially received from a respective processor core 11 by north bridge 12. Requests for access to memory 6 may be initiated responsive to the execution of certain instructions, and may also be initiated responsive to prefetch operations.

As shown in FIG. 1, graphics processing unit 14 is coupled to display unit 3, which may be any suitable type of display. GPU 14 may perform various video processing functions and provide the processed information to display unit 3 for output as visual information.

In one embodiment, memory controller 18 may receive memory requests conveyed from north bridge 12. Data accessed from memory 6 responsive to a read request (including prefetches) may be conveyed by memory controller 18 to the requesting agent via north bridge 12. Responsive to a write request, memory controller 18 may receive both the request and the data to be written from the requesting agent via north bridge 12. If multiple memory access requests are pending at a given time, memory controller 18 may arbitrate between these requests. It is noted that in some embodiments, memory controller 18 may be part of the north bridge 12.

In various embodiments, the memory 6 may be implemented as a plurality of memory modules. As such, each of the memory modules may include one or more memory devices (e.g., memory chips) mounted thereon. In another embodiment, the memory 6 may include one or more memory devices mounted on a motherboard or other carrier upon which processing node 2 may also be mounted. In yet another embodiment, at least a portion of memory 6 may be implemented on the die of processing node 2 itself. Embodiments having a combination of the various implementations described above are also possible and contemplated. The devices may be implemented using any of a variety of random access memories (RAM). Thus, memory 6 may include memory devices in the static RAM (SRAM) family or in the dynamic RAM (DRAM) family. For example, memory 6 may be implemented using (but is not limited to) double data rate (DDR) DRAM, DDR2 DRAM, DDR3 DRAM, and so forth.

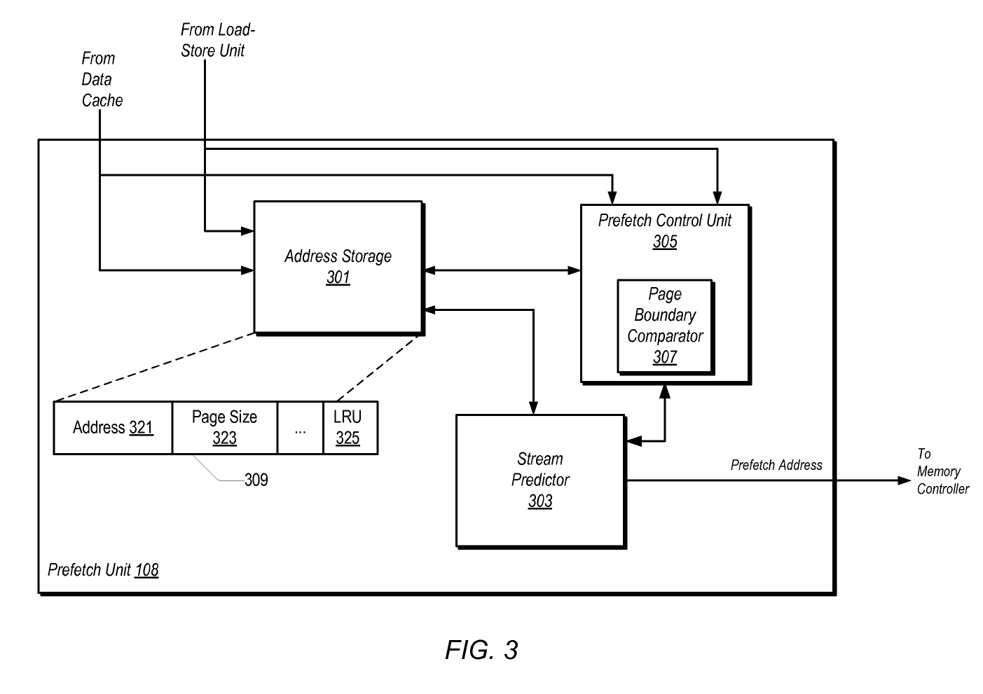

Referring to FIG. 2, a block diagram of one embodiment of a representative processor core of FIG. 1 is shown. It is noted that components that correspond to components shown in FIG. 1 are numbered identically for clarity and simplicity. The processor core 11 includes a dispatch unit 104 that is coupled to scheduler(s) 118, which is in turn coupled to execution units 124 which are coupled to a result bus 130. In addition, processor core 11 includes a retirement queue 102 that is coupled to the dispatch unit 104 and to the scheduler(s) 118. The processor core 11 also includes a register file 116 that is coupled to the execution units 124 and to the result bus 130. The processor core 11 also includes a level one (L1) instruction cache 106 and an L1 data cache 128, which are coupled to the north bridge 12. The processing node 11 also includes a prefetch unit 108 that is coupled to the L1 instruction cache 106 and to the data cache 128, and which will be discussed in greater detail below in conjunction with the description of FIG. 3. The processor core 11 further includes an L2 cache 129, which is coupled to the north bride 12.

In one embodiment, the dispatch unit 104 may be configured to receive instructions from the instruction cache 106 and to dispatch operations to the scheduler(s) 118. One or more of the schedulers 118 may be coupled to receive dispatched operations from the dispatch unit 104 and to issue operations to the one or more execution unit(s) 124. The execution unit(s) 124 may include one or more integer units, and one or more floating point units (both not shown). At least one load-store unit 126 is also included among the execution units 124 in the embodiment shown. Results generated by the execution unit(s) 124 may be output to the result bus 130 (a single result bus is shown here for clarity, although multiple result buses are possible and contemplated). These results may be used as operand values for subsequently issued instructions and/or stored to the register file 116. In one embodiment, the processor core may support out of order execution. The retire queue 102 may be configured to determine when each issued operation may be retired. The execution units 124 are configured to execute instructions stored in a system memory (e.g., memory 6 of FIG. 1). Many of these instructions may also operate on data stored in memory 6.

It is noted that the processing node 11 may also include many other components that have been omitted here for simplicity. For example, the processing node 11 may include a branch prediction unit (not shown) that may predict branches in executing instruction threads and a translation lookaside buffer (TLB) that may translate virtual addresses to physical addresses used for accessing memory 6. In some embodiments (e.g., if implemented as a stand-alone processor), processor core 11 may also include a memory controller configured to control reads and writes with respect to memory 6.

The L1 instruction cache 106 may store instructions for fetch by the dispatch unit 104. Instruction code may be provided to the instruction cache 106 for storage by prefetching code from the system memory 200 through the prefetch unit 108. Instruction cache 106 may be implemented in various configurations (e.g., set-associative, fully-associative, or direct-mapped).

The prefetch unit 108 may prefetch instructions from the memory 6 for storage within the instruction cache 106. In one embodiment, the prefetch unit 108 may be configured to prefetch instructions from different sized memory pages. More particularly, as described further below, prefetch unit 108 may maintain page size information for each data stream for which it is prefetching. An exemplary embodiment of a prefetch unit 108 will now be discussed in further detail below.

Turning to FIG. 3, a block diagram of one embodiment of prefetch unit 108 is shown. The prefetch unit 108 includes an address storage 301 which is coupled to a prefetch control unit 305 and to a stream predictor 303. Generally, prefetch unit 108 is configured to generate prefetch addresses. The prefetch unit 108 may monitor the addresses that the miss data cache 128 in order to detect patterns in the miss stream, and generate prefetch addresses in response to the detected patterns. In various embodiments, the prefetch unit 108 may be representative of any type of prefetcher. More particularly, in one embodiment, the prefetch unit 108 may attempt to detect a stride access pattern among miss addresses and may generate the next address in the pattern if a strided access pattern is detected. A stride access pattern may exist if consecutive addresses in the pattern are separated by a fixed stride amount. Other addresses which are not included in the pattern may intervene between consecutive addresses in the pattern. The next address in the pattern may be generated by adding the stride amount to the most recent address in the pattern. However, in other embodiments, the prefetch unit 108 may detect other types of patterns such as instruction pointer patterns, for example.

The address storage 301 may store and maintain information from the miss addresses which have been observed by the prefetch unit 108. The address storage 301 comprises at least one entry, and may include any number of entries. In one embodiment, each entry may represent a pattern of miss addresses, where consecutive addresses within the pattern are separated by a fixed stride amount. The most recent address of a given pattern may be recorded in the corresponding entry of the address storage 301, along with other information (not shown) that may be used to indicate of the number of addresses detected in that pattern. The more addresses which have matched the pattern, the more likely the pattern may be to repeat in the future. The prefetch control unit 305 may receive information (e.g., a miss signal), for example, from the data cache 128 (which may indicate, when asserted, that the address presented to the data cache 128 by the load/store unit 26 is a miss in the data cache 128), and may update the address storage 301 when a miss address is received. While a miss signal is used in the present embodiment, other embodiments may use a hit signal or any other indication of the hit/miss status of an address presented to data cache 128.

In the embodiment of FIG. 3, an exemplary entry 309 of the address storage 301 is shown. The entry 309 includes an address field 321, a page size field 323, and a least recently used field (LRU) 325. However, other information stored within entry 309 has been omitted for simplicity.

The Address field 321 stores the most recent address which was detected by prefetch control unit 305 to be part of the access pattern represented by entry 309. In various embodiments, the whole physical address or only a portion of the physical address may be stored. Particularly, in one implementation, the bits of the physical address which are not part of the cache line offset may be stored. The cache line offset portion (in this case, six bits since cache lines are 64 bits, although other embodiments may employ different cache line sizes) is not stored since cache lines are prefetched in response to prefetch addresses generated by prefetch unit 108 and thus strides of less than a cache line are not of interest to prefetch unit 108. Viewed in another way, the granularity of addresses in prefetch unit 108 is a cache line granularity. Any granularity may be used in other embodiments, including larger and smaller granularities. Generally, addresses are said to “match” if the bits which are significant to the granularity in use are equal. For example, if a cache line granularity is used, the bits which are significant are the bits excluding the cache line offset bits. Accordingly, addresses match if bits 35:6, for example, of the two addresses are equal.

The page size field stores a value indicative of the memory page size to which the address in the entry corresponds. The page size may be included with the address information received by the prefetch unit 108. The page size may be used by the prefetch control unit 305 to ensure that a page boundary is not being crossed when prefetching addresses.

In one embodiment, when a miss address is received by prefetch control unit 305, the miss address is compared to the addresses recorded in the address storage 301 to determine if the miss address matches any of the recorded patterns. If the miss address does not match one of the recorded patterns, prefetch control unit 305 may allocate an entry in the address storage 301 to the address. In this manner, new patterns may be detected. However, if prefetch control unit 305 detects that the miss address matches one of the recorded patterns, prefetch control unit 305 may change information (e.g., increment a confidence counter) in the corresponding entry and may store the miss address in the corresponding entry.

The LRU field 325 stores a least recently used (LRU) value ranking the recentness of entry 309 among the entries in the address storage 309. The least recently used entry may be replaced when an address not fitting any of the patterns in the address storage 309 is detected, and the prefetch unit 108 attempts to track a new pattern beginning with that address. It is noted that while the LRU ranking is used in the present embodiment, any replacement strategy may be used (e.g. modified LRU, random, etc.).

In one embodiment, the prefetch unit 108 may operate on physical addresses (i.e. addresses which have been translated through the virtual to physical address translation mechanism of processor core 11). Accordingly, the addresses stored in the address storage 301 are physical addresses. In this manner, translation of prefetch addresses may be avoided. Additionally, in such embodiments, since the prefetch unit 108 may not generate prefetch addresses which cross a page boundary (since virtual pages may be arbitrarily mapped to physical pages, a prefetch in the next physical page may not be part of the same stride pattern of virtual addresses), the prefetch unit 108 keeps track of the page size of each stream for which it is generating prefetch addresses.

More particularly, as described above the prefetch unit 108 receives a page size indication with each address. If a new entry is allocated for the address because the address does not match any of the entries in the address storage 301, the prefetch control unit 305 stores the page size value within the page size field in the entry. In one embodiment, the page boundary comparator 307 may compare prefetch addresses generated by the stream predictor 303 to ensure that a prefetch address does not cross a page boundary. Accordingly, for each prefetch address generated, the page boundary comparator 307 may use the page size information in the entry corresponding to the current prefetch address to determine whether the current prefetch address is within the page boundary for the current stream. More particularly, the page size value in the page size entry may be used to set the limits within the page boundary comparator 307 for each stream independently. This is in contrast to conventional prefetchers in which all streams are subject to the page boundary for one page size, usually the minimum page size supported by the system (e.g., 4 KB). In such a conventional system, if the page size being accessed is, for example, 2 GB, the prefetcher may stop prefetching each time an address is going to cross a 4 KB page boundary. Thus, the conventional prefetcher would need to invalidate that entry, and start and train a new entry to continue prefetching the same stream.

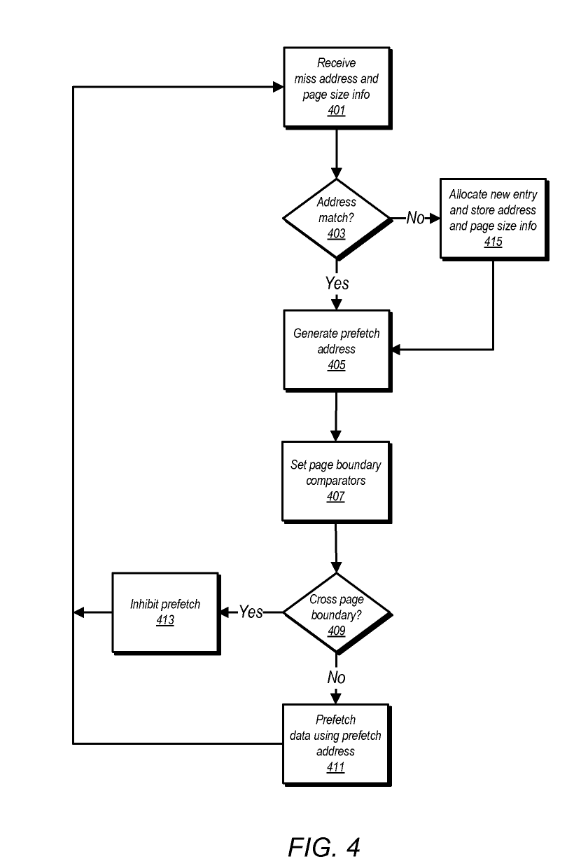

In FIG. 4, a flow diagram describing operational aspects of the prefetch unit of FIG. 2 and FIG. 3 is shown. Referring collectively to FIG. 2 through FIG. 4 and beginning in block 401 of FIG. 4, prefetch unit 108 receives an address and page size information from the data cache 128. More particularly, in one embodiment, the prefetch unit 108 may receive a number of bits of the physical address of a cache miss, along with the page size of the memory page that corresponds to the miss address.

The prefetch control unit 305 may check the address storage 301 to see if there is an entry that matches the address (block 403). For example, prefetch control unit 305 may compare the received address with the address stream associated with address stored in the address field 321 of each entry. If the received address matches one of the entries, the stream predictor 303 generates a prefetch address (block 405).

The page boundary comparator 307 checks the prefetch address to ensure that it will not cross the page boundary of the current page of memory that the prefetch address will access (block 407). More particularly, the prefetch control unit 305 may retrieve the page size value from the page size field 323 of the current entry to establish the compare values in the page boundary comparator 307. If the page boundary will be crossed, the prefetch control unit 305 may inhibit the prefetch, and in one embodiment, invalidate the entry in the address storage 301, making that entry available for re-allocation (block 413). In one implementation, the prefetch control unit 305 may change the LRU field 325 of all the entries such that the entry that is being invalidated will have a value that indicates it is the least recently used entry and is therefore subject to reallocation.

Referring back to block 407, if the page boundary will not be crossed, prefetch control unit 305 prefetches the data at the prefetch address (block 411). In one embodiment, the prefetch control unit 305 forwards the prefetch address to the north bridge 12 and or to the memory controller 18. Operation proceeds as described above in conjunction with the description of block 401.

Referring back to block 403, if the received miss address does not match any address within the address storage 301, the prefetch control unit 305 may allocate an entry and store the address and page size information to start a new data stream (block 415). In one embodiment, prefetch control unit 305 may select an entry that has not yet been allocated, or if there are no unallocated entries, the prefetch control unit 305 may allocate the entry having an LRU field 325 that contains a value that is indicative that the entry is the least recently used entry. Operation proceeds as described above in conjunction with the description of block 405 in which a prefetch address is generated.

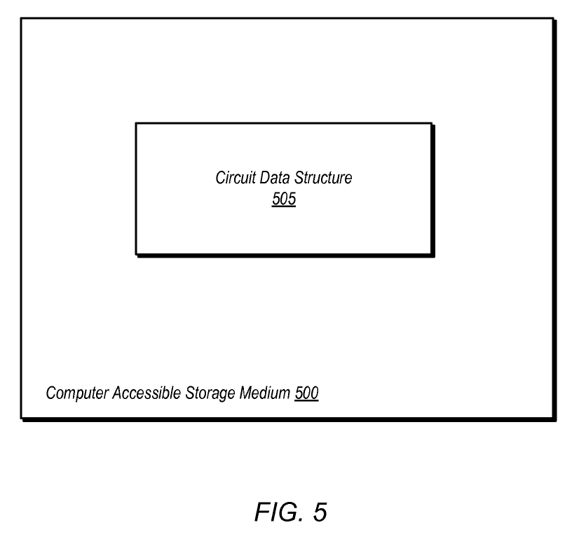

Turning to FIG. 5, a block diagram of a computer accessible storage medium 500 including a circuit database 505 that is representative of at least portions of the processing node 2 of FIG. 1 is shown. Generally speaking, a computer accessible storage medium 500 may include any non-transitory storage media accessible by a computer during use to provide instructions and/or data to the computer. For example, a computer accessible storage medium 500 may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Generally, the database 505 of the processing node 12 carried on the computer accessible storage medium 500 may be a database or other data structure which can be read by a program and used, directly or indirectly, to fabricate the hardware comprising the processing node 2. For example, the database 505 may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the processing node 2. The netlist may then be placed and routed to produce a data set describing geometric shapes to be applied to masks. The masks may then be used in various semiconductor fabrication steps to produce a semiconductor circuit or circuits corresponding to the processing node 2. Alternatively, the database 505 on the computer accessible storage medium 500 may be the netlist (with or without the synthesis library) or the data set, as desired.

While the computer accessible storage medium 500 carries a representation of the processing node 2, other embodiments may carry a representation of any portion of the processing node 2, such as one of the processor cores 11, as desired.

Thus, the above embodiments may provide a prefetch mechanism that enables many types of prefetchers to prefetch addresses within that page size of the page within which the address falls, rather than having to stop at a page boundary of the minimum page size of the system. Thus, prefetch unit 108, which is page size aware, may be more efficient during prefetch operations.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a prefetch unit including a storage adaptable to store a plurality of entries, each entry corresponding to a different prefetch data stream, wherein each entry is configured to store information corresponding to a page size of the prefetch data stream;
wherein for each entry, the prefetch unit is configured to determine whether a prefetch of data in the data stream will cross a page boundary associated with the data stream based upon the page size information.

2. The processor as recited in claim 1, wherein prefetch unit is configured to receive the page size information with an address corresponding to a cache miss.

3. The processor as recited in claim 2, wherein for each entry having an active data stream, the prefetch unit is configured to generate a prefetch address based upon the received address.

4. The processor as recited in claim 3, wherein the prefetch unit includes compare logic configured to compare the prefetch address for a given data stream to an address corresponding to the page boundary defined by the page size information for the given data stream.

5. The processor as recited in claim 1, wherein in response to determining that the prefetch of data will cross the page boundary, the prefetch unit is configured to inhibit prefetching the data.

6. The processor as recited in claim 1, wherein in response to determining that the prefetch of data will not cross the page boundary, the prefetch unit is configured to prefetch the data.

7. A prefetch unit comprising:
a prefetch control unit;
a storage having a plurality of entries and coupled to the prefetch control unit, wherein each entry is configured to store an address corresponding to a different prefetch data stream, and information corresponding to a page size of the data stream;
a stream predictor coupled to the storage and configured to generate a prefetch address for each active entry;
wherein for each entry, the prefetch control unit is configured to determine whether the data stream corresponding to the prefetch address will cross a page boundary associated with the data stream based upon the page size information.

8. The prefetch unit as recited in claim 7, wherein prefetch unit is configured to receive each address corresponding to a different prefetch data stream in response to a cache miss, and to receive with the address the information corresponding to the page size.

9. The prefetch unit as recited in claim 7, wherein the prefetch control unit includes compare logic configured to compare the prefetch address for a given data stream to an address corresponding to the page boundary defined by the page size information for the given data stream.

10. The prefetch unit as recited in claim 7, wherein in response to determining that the prefetch of data will cross the page boundary, the prefetch control unit is configured to inhibit prefetching the data.

11. The prefetch unit as recited in claim 10, wherein in response to determining that the prefetch of data will cross the page boundary, the prefetch control unit is configured to reallocate the entry corresponding to the data stream that will cross the page boundary.

12. A system comprising:
a processor node including one or more processor cores, wherein at least one processor core includes a prefetch unit, wherein each prefetch unit includes:
a prefetch control unit;
a storage having a plurality of entries and coupled to the prefetch control unit, wherein each entry is configured to store an address corresponding to a different prefetch data stream, and information corresponding to a page size of the data stream;
a stream predictor coupled to the storage and configured to generate a prefetch address for each active entry;
wherein for each entry, the prefetch control unit is configured to determine whether the data stream corresponding to the prefetch address will cross a page boundary associated with the data stream based upon the page size information.

13. The system as recited in claim 12, wherein the prefetch unit is configured to receive each address corresponding to a different prefetch data stream in response to a cache miss, and to receive the information corresponding to the page size with the received address.

14. The system as recited in claim 12, wherein the prefetch control unit includes compare logic configured to compare the prefetch address for a given data stream to an address corresponding to the page boundary defined by the page size information for the given data stream.

15. The system as recited in claim 12, wherein in response to determining that the prefetch of data will cross the page boundary, the prefetch control unit is configured to inhibit prefetching the data.

16. A method comprising:
a prefetch unit of a processor core storing within each entry of a storage an address corresponding to a different prefetch data stream, and information corresponding to a page size of the prefetch data stream;
wherein for each entry, the prefetch unit determining whether a prefetch of data in the data stream will cross a page boundary associated with the data stream based upon the page size information.

17. The method as recited in claim 17, further comprising comparing the prefetch address for a given data stream to an address corresponding to the page boundary defined by the page size information for the given data stream.

18. The method as recited in claim 17, in response to determining that the prefetch of data will cross the page boundary, the prefetch unit inhibiting prefetching the data and reallocating the entry corresponding to the prefetch data that will cross the page boundary.

19. A computer readable medium storing a data structure which is operated upon by a program executable on a computer system, the program operating on the data structure to perform a portion of a process to fabricate an integrated circuit including circuitry described by the data structure, the circuitry described in the data structure including:
a prefetch unit including a storage, wherein the storage includes a plurality of entries, each entry corresponding to a different prefetch data stream, wherein each entry is configured to store information corresponding to a page size of the prefetch data stream;
wherein for each entry, the prefetch unit is configured to determine whether a prefetch of data in the data stream will cross a page boundary associated with the data stream based upon the page size information.

20. The computer readable medium as recited in claim 19, wherein the prefetch unit includes compare logic configured to compare the prefetch address for a given data stream to an address corresponding to the page boundary defined by the page size information for the given data stream.
